(19) United States
(12) Patent Application Publication
(10) Pub. No.: US 2014/0303864 A1
(43) Pub. Date: Oct. 9, 2014

(54) METHOD AND SYSTEM FOR CONTROLLING A DIFFERENTIAL CONFIGURATION

(71) Applicants: Daniel ENGBLOM, Bonässund (SE); Pontus KARLSSON, Bromma (SE); BAE Systems Hägglunds Aktiebolagrnsk, Örnsköldsvik (SE)

(72) Inventors: Pontus Karlsson, Bromma (SE); Daniel Engblom, Bonassund (SE)

(73) Assignee: BAE Systems Häggluds Aktiebolag, Örnskoldsvik (SE)

(21) Appl. No.: 14/119,435

(22) PCT Filed: May 23, 2012
(86) PCT No.: PCT/SE2012/050555

§ 371 Date: May 16, 2014

(30) Foreign Application Priority Data
May 23, 2011 (SE) 1150480-0

(51) Int. Cl. F16H 61/22

(52) U.S. Cl. CPC F16H 61/22
USPC 701/69

(57) ABSTRACT

The present invention relates to a method for controlling a differential configuration (40; 400) for at least two for differential drive arranged drive wheels of a motor vehicle (1; 2; 3), said differential drive being arranged to assume a locked and an open position respectively comprising the step of controlling the differential configuration between a locked and a non-locked condition in dependence of predetermined vehicle parameters, comprising the step of: controlling (S1) the differential configuration (40, 400) between a locked and a non-locked condition in dependence of centre of gravity positions of the vehicle.

The present invention also relates to a system for controlling a differential configuration (40, 400). The present invention also relates to a differential configuration. The present invention also relates to a motor vehicle. The present invention also relates to a computer program and a computer program product.

### TECHNICAL FIELD

The invention relates to a method for controlling a differential configuration according to the preamble of claim 1. The invention relates to a system for controlling a differential configuration according to the preamble of claim 8. The invention further relates to a differential configuration according to the preamble of claim 15. The invention also relates to a motor vehicle. The invention in addition relates to a computer program and a computer program product.

### BACKGROUND ART

WO 81/02049 shows a control system for a lockable differential in a vehicle, where the differential is unlocked in the neutral position and where the differential is locked during drive straight forward within a predetermined lower part of the total vehicle speed range and is unlocked during transition to a predetermined higher part of the total vehicle speed range. Further there is possibility for an operator to manually lock the differential also in the higher portion of the vehicle speed range.

WO 2004/087453 shows a rear-wheel driven vehicle with an electrically controlled differentiation of a differential in the vehicle, wherein the differentiation is controlled in dependence of measured input data from sensors on the vehicle.

In heavy vehicles such as work vehicles, e.g. articulated vehicles with multi-wheel drive and a vertically adjustable dredger ladle carrying load, situations may occur, e.g. in rough terrain with narrow passages, where the vehicle gets stuck and starts to slip resulting in inefficient drive. Hereby differential locking of drive wheel is required in such situations in order for the vehicle to be driven.

### OBJECTS OF THE INVENTION

An object of the present invention is to provide a method for controlling a differential configuration for a motor vehicle facilitating efficient drive of the vehicle.

An object of the present invention is to provide a system for controlling a differential configuration for a motor vehicle facilitating efficient drive of the vehicle.

### SUMMARY OF THE INVENTION

These and other objects, apparent from the following description, are achieved by a method and system for controlling a differential configuration, a differential configuration, a motor vehicle, a computer program and a computer program product, which are of the type stated by way of introduction and which in addition exhibits the features recited in the characterising clause of the appended claims 1, 8, 15, 24, 27 and 28. Preferred embodiments of the method, system, differential configuration and motor vehicle are defined in appended dependent claims 2-7, 9-14, 16-23 and 25-26.

According to the invention the objects are achieved by a method for controlling a differential configuration for at least two for differential drive arranged drive wheels of a motor vehicle, said differential drive being arranged to assume a locked and an open position respectively comprising the step of controlling the differential configuration between a locked and a non-locked condition in dependence of predetermined vehicle parameters, comprising the step of: controlling the differential configuration between a locked and a non-locked condition in dependence of centre of gravity positions of the vehicle. Hereby efficient drive of e.g. an articulated vehicle is facilitated where the centre of gravity position varies and affects the traction capability of the vehicle, such as a loader with vertically adjustable dredger ladle, in that the differential configuration may be kept locked or in a non-locked condition depending on the centre of gravity position, the centre of gravity position e.g. depending on e.g. the orientation of the vehicle, articulation angle, elevation of dredger ladle, load etc.

According to an embodiment the method comprises the step of determining said centre of gravity positions of the vehicle based upon one or more vehicle parameters comprising steering angle, load and vehicle physics. Hereby optimization of drive torque for efficient propulsion and traction capability of a vehicle such as a work vehicle is facilitated.

According to an embodiment of the method the step of controlling the differential configuration between a locked and a non-locked condition also comprises any of the vehicle parameters speed, steering angle and drive torque.

According to an embodiment the method comprises the step of: i) in a normal case of prevalent vehicle drive keeping the differential configuration in a locked condition for securing the traction capability; and ii) controlling the differential configuration to an non-locked condition by deviations from said normal case of prevalent vehicle drive represented by predetermined vehicle parameters comprising centre of gravity position of the vehicle for continued securing of the traction capability of the vehicle.

By in a normal case of prevalent vehicle drive keeping the differential configuration locked the traction capability will be optimized in that the differential configuration of the vehicle already is in the locked condition such that all drive members such as drive wheels and/or drive tracks rotates at the same speed, wherein, by e.g. unforeseen events which, in case the differential configuration would not be locked, would affect the traction capability in such a way that e.g. the vehicle gets stuck, slides or the corresponding, demanding locking of the differential configuration, hereby never occurs. The differential configuration is consequently only changed to a non-locked condition if it is really required in order to facilitate traction capability for the vehicle and is unlocked only for the drive members where it is required and to the degree required such that drive torque is distributed in an optimal way to the respective drive member. Consequently the method facilitates very efficient propulsion of e.g. work vehicles, e.g. an articulated work vehicle such as a mining vehicle, a loader with a height adjustable dredger ladle, a dumper or the corresponding, where the articulated vehicle according to an embodiment is constituted by a multi-wheel driven vehicle. The vehicle may also be constituted by a tracked vehicle which may be articulated and multi-wheel driven, i.e. several tracks are driven.

According to an embodiment the method comprises the step of controlling the differential configuration to said non-locked condition if i) the centre of gravity position of the vehicle differs from predetermined positions and: the speed exceeds a first predetermined value and/or the drive torque falls below a predetermined value, or ii) if the speed exceeds a second predetermined value being greater than said first predetermined value. By controlling the differential configuration in such a way drive torque is optimized such that traction capability of the vehicle is secured.

According to an embodiment the method comprises the step of controlling the differential configuration to said non-locked condition if i) the steering angle exceeds a predetermined value and: the speed exceeds a first predetermined value and/or the drive torque falls below a predetermined value, or ii) if the speed exceeds a second predetermined value being greater than said first predetermined value. By controlling the differential configuration in such a way drive torque is optimized such that traction capability of the vehicle is secured.

According to an embodiment the method comprises the step of controlling the differential configuration to a determined mutual torque distribution of the drive members. Hereby the torque distribution of the respective drive wheel may be optimized for the traction capability of the vehicle.

According to the invention the objects are achieved with a system for controlling a differential configuration for at least two for differential drive arranged drive wheels of a motor vehicle, said differential drive being arranged to assume a locked and an open position respectively, means being presently arranged for controlling the differential configuration between a locked and a non-locked condition in dependence of predetermined vehicle parameters, comprising means for controlling the differential configuration between a locked and a non-locked condition in dependence of centre of gravity positions of the vehicle. Hereby efficient drive of e.g. an articulated vehicle is facilitated where the centre of gravity position varies and affects the traction capability of the vehicle, such as a loader with vertically adjustable dredger ladle, in that the differential configuration may be kept locked or in a non-locked condition depending on the centre of gravity position, the centre of gravity position e.g. depending on e.g. the orientation of the vehicle, articulation angle, elevation of dredger ladle, load etc.

According to an embodiment of the system said means for controlling the differential configuration between a locked and a non-locked condition also comprises any of the vehicle parameters speed, steering angle and drive torque. Hereby optimization of drive torque for efficient propulsion and traction capability of a motor vehicle is facilitated.

According to an embodiment the system comprises means for determining said centre of gravity positions of the vehicle based upon one or more vehicle parameters comprising steering angle, load and vehicle physics. Hereby optimization of drive torque for efficient propulsion and traction capability of a vehicle such as a work vehicle is facilitated.

According to an embodiment the system comprises means for in a normal case of prevalent vehicle drive keeping the differential configuration in a locked condition for securing the traction capability; and means for controlling the differential configuration to an non-locked condition by deviations from said normal case of prevalent vehicle drive represented by predetermined vehicle parameters comprising centre of gravity position of the vehicle for continued securing of the traction capability of the vehicle.

By utilising means for in a normal case of prevalent vehicle drive keeping the differential configuration locked the traction capability will be optimized in that the differential configuration of the vehicle already is in the locked condition such that all drive members such as drive wheels and/or drive tracks rotates at the same speed, wherein, by e.g. unforeseen events which, in case the differential configuration would not be locked, would affect the traction capability in such a way that e.g. the vehicle gets stuck, slides or the corresponding, demanding locking of the differential configuration, hereby never occurs. The differential configuration is consequently only changed to a non-locked condition if it is really required in order to facilitate traction capability for the vehicle and is unlocked only for the drive members where it is required and to the degree required such that drive torque is distributed in an optimal way to the respective drive member. Consequently the method facilitates very efficient propulsion of e.g. work vehicles, e.g. an articulated work vehicle such as a mining vehicle, a loader with a height adjustable dredger ladle, a dumper or the corresponding, where the articulated vehicle according to an embodiment is constituted by a multi-wheel driven vehicle. The vehicle may also be constituted by a tracked vehicle which may be articulated and multi-wheel driven, i.e. several tracks are driven.

According o an embodiment the system comprises means for controlling the differential configuration to said non-locked condition if i) the centre of gravity position of the vehicle differs from predetermined positions and: the speed exceeds a first predetermined value and/or the drive torque falls below a predetermined value, or ii) if the speed exceeds a second predetermined value being greater than said first predetermined value. By utilising means for controlling the differential configuration in such a way drive torque is optimized such that traction capability of the vehicle is secured.

According to an embodiment the system comprises means for controlling the differential configuration to said non-locked condition if i) the steering angle exceeds a predetermined value and: the speed exceeds a first predetermined value and/or the drive torque falls below a predetermined value, or ii) if the speed exceeds a second predetermined value being greater than said first predetermined value. By utilising means for controlling the differential configuration in such a way drive torque is optimized such that traction capability of the vehicle is secured.

The invention further relates to a differential configuration arranged to be controlled by means of a system according to any of the embodiments above, wherein said differential configuration comprises at least one differential arrangement comprising a first planetary gear configuration being drivingly connected to a first drive member, a second planetary gear configuration being drivingly engaged to said first planetary gear configuration via said output shaft, said second planetary gear configuration being drivingly connected to a second drive member; an electric motor being arranged between said first and second planetary gear configuration, said first planetary gear configuration being arranged to co-act with said second planetary gear configuration for providing a differential function. Hereby efficient drive and differential drive is facilitated.

According to an embodiment of the differential configuration the ring gears of the first and second planetary gear configuration are engaged via a reversing assembly for said differential function. This facilitates an efficient differential function with less wear on components of the differential configuration. Hereby the differential configuration may be fully locked, since the differential arrangement is separated from the drive shaft. When the differential is locked the braking is provided on non-rotating components such that wear of components during operation is reduced. Further torque vectoring is facilitated.

According to an embodiment of the differential configuration said reversing assembly comprises shaft configuration separated from said drive shaft. Hereby differential drive is separated from drive of the motor rendering the above mentioned advantages.

According to an embodiment of the differential configuration said reversing assembly comprises a rotational direction change configuration, connected to the ring gears of the first and second planetary gear configurations via said shaft configuration. This is an efficient way of providing said opposite rotation so as to provide an efficient differential function.

According to an embodiment of the differential configuration at least one differential control unit exists, being operable to engage and disengage said reversing assembly for controlling said differential configuration. Hereby torque vectoring and/or fully locked and/or limited slip differential may be achieved.

According to an embodiment of the differential configuration said at least one differential control unit comprises a coupling configuration for braking said reversing assembly. Hereby fully locked or limited slip differential may be achieved.

According to an embodiment of the differential configuration said at least one differential control unit comprises a motor. Hereby torque vectoring may be achieved.

According to an embodiment of the differential configuration at least one differential control unit is presently arranged to block a first and/or second carrier of the planetary gear configuration. Hereby the drive member may be brought to rotate with the same speed or different speed and consequently differential function may be provided.

According to an embodiment of the differential configuration said at least one differential control unit is arranged to lock said first and second carrier such that rotation of drive members is prevented. Hereby braking of the vehicle is facilitated, which may be utilised for parking brake or emergency brake.

### BRIEF DESCRIPTION OF THE DRAWINGS

A better understanding of the present invention will be had upon the reference to the following detailed description when read in conjunction with the accompanying drawings, wherein like reference characters refer to like parts throughout the several views, and in which:

FIG. 1-6 schematically illustrates different view of a motor vehicle according to the present invention;

FIG. 7-8 schematically illustrates different views of a motor vehicle according to the present invention;

FIG. 9 schematically illustrates a system for controlling a differential configuration according to an embodiment of the present invention;

FIG. 10 schematically illustrates a system for controlling a differential configuration according to an embodiment of the present invention;

FIG. 11 schematically illustrates a system for controlling a differential configuration according to an embodiment of the present invention;

FIG. 12 schematically illustrates a motor vehicle according to an embodiment of the present invention;

FIG. 13a schematically illustrates a differential configuration according to the present invention;

FIG. 13b schematically illustrates a differential arrangement of a differential configuration according to an embodiment of the present invention;

FIGS. 14a and 14 schematically illustrate different embodiments of differential control units for controlling a differential configuration according to the present invention;

FIG. 15 schematically illustrates a block diagram of a method for controlling a differential configuration according to an embodiment of the present invention;

FIG. 16 schematically illustrates a block diagram of a method for controlling a differential configuration according to an embodiment of the present invention; and

FIG. 17 schematically illustrates a computer according to an embodiment of the present invention.

### DETAILED DESCRIPTION

Hereinafter the term “link” refers to a communication link which may be a physical connector, such as an optoelectronic communication wire, or a non-physical connector such as a wireless connection, for example a radio or microwave link.

Hereinafter the term “drive member” refers to a driving output ground engaging member for propulsion of a motor vehicle comprising drive wheel or driving wheels of a wheeled vehicle, and/or drive tracks or driving tracks of a tracked vehicle.

With the term “locked condition” of a differential configuration is hereinafter intended a condition where opposing drive members are allowed to rotate with the same rotational speed. With the term “non-locked condition” is hereinafter intended a condition where the differential configuration is separated from said locked condition, said locked condition comprising open condition and partly open conditions in which a certain blockage of the differential configuration is allowed. Hereby in the non-locked condition the drive members are allowed to rotate with different rotational speed.

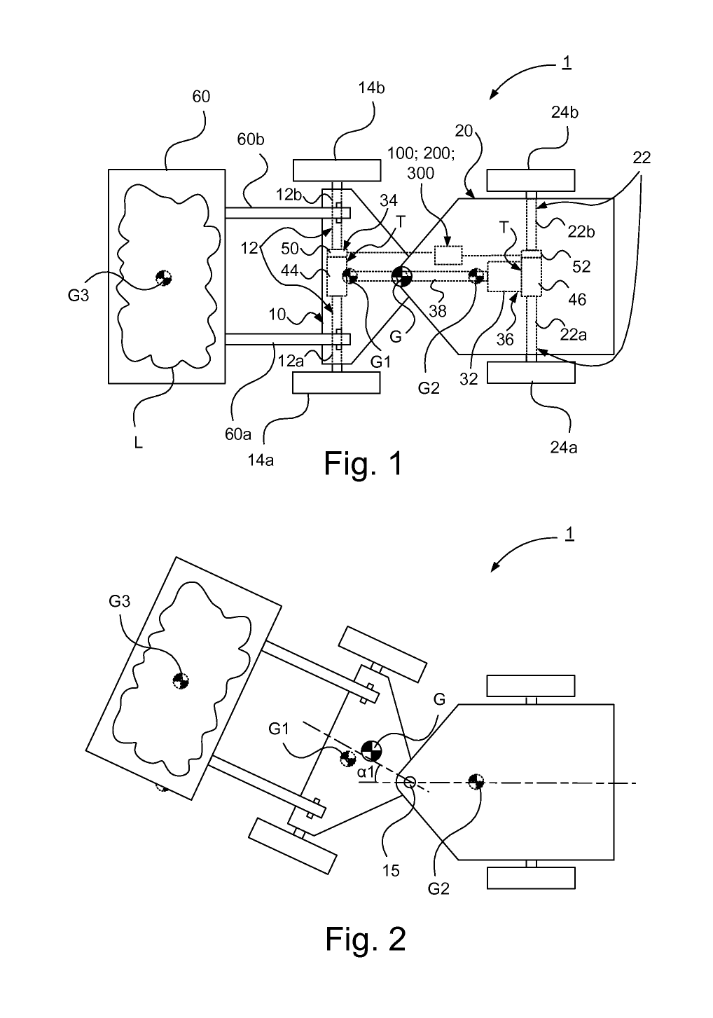

FIG. 1-6 schematically illustrates different views of a motor vehicle 1 according to the present invention. The motor vehicle 1 is according to this embodiment constituted by a work vehicle. The motor vehicle 1 is according to this embodiment constituted by an articulated vehicle. The motor vehicle 1 according to this embodiment is constituted by a multi-wheel drive vehicle.

The articulated vehicle 1 has a front vehicle unit 10 and a rear vehicle unit 20. The front and rear vehicle units 10, 20 are pivotable about a steering device 15 by means of which the vehicle 1 is arranged to be steered.

The articulated vehicle 1 comprises a driveline 30 for driving the vehicle 1. The driveline 30 comprises a motor 32 for propulsion of the vehicle 1, and a transmission configuration T connected to said motor 32 for transmitting power from motor 32 to drive members in the form of drive wheels of the vehicle 1. The driveline 30 further comprises a differential configuration 40 for transmitting drive torque from motor 32 to drive wheels.

The driveline 30 comprises a front transmission configuration 34 arranged in the front vehicle unit 10 for driving a front drive shaft 12, the front transmission configuration 34 comprising a front differential device 44 which may be constituted by any suitable differential for providing a differential function.

The driveline 30 further comprises a rear transmission configuration 36 arranged in the rear vehicle unit 20 for driving a rear drive shaft 22, the rear transmission configuration 36 comprising a rear differential device 46 which may be constituted by any suitable differential for providing a differential function.

The transmission configuration T comprises the front transmission configuration 34 and the rear transmission configuration 36. The transmission configuration T comprises the differential configuration 40. The differential configuration 40 comprises the front differential device 44, and the rear differential device 46.

The driveline 30 may comprise any suitable transmission configuration comprising one or more electric motors and/or at least one combustion engine and/or other energy source such as e.g. net connection, fuel cell, battery or the corresponding. The driveline 30 may also comprise cardan shaft 38 for power transfer.

The front drive shaft 12 comprises a left drive shaft portion 12a and a right drive shaft portion 12b. the front vehicle unit 10 comprises a front pair of drive wheels 14 comprising a front left drive wheel 14a connected to left drive shaft portion 12a and an opposing front rear drive wheel 14b connected to the right drive shaft portion 12b.

The front vehicle unit 10 further comprises a differential control unit 50 connected to the front differential device 44 arranged to control the front differential device 44 based upon predetermined vehicle parameters. The front differential device 44 is connected to the front drive shaft 12 in such a way that drive torques are transferred from the differential device 44 via the respective drive shaft portion 12a, 12b to the respective front drive shaft 14a, 14b.

The rear drive shaft 22 comprises a left drive shaft portion 22a and a rear drive shaft portion 22b. The rear vehicle unit 10 comprises a rear pair of drive wheels 24 comprising a rear left drive wheel 24a connected to the left drive shaft portion 22a and an opposing rear right drive wheel 24b connected to the right drive shaft portion 22b.

The rear vehicle unit 10 further comprises a differential control unit 52 connected to the rear differential device 46 arranged to control the rear differential device 46 based upon predetermined vehicle parameters. The rear differential device 46 is connected to the rear drive shaft 22 in such a way that drive torque is transmitted from the differential device 46 via the respective drive shaft portion 22a, 22b to the respective rear drive wheel 24a, 24b. The rear vehicle unit 20 of the articulated vehicle 1 has according to this embodiment a cab 26.

The articulated vehicle 1 comprises a dredger ladle connected to the front vehicle unit 10 via lifting arms 60a, 60b arranged to receive and remove load L, where the load L may be constituted by any load such as gravel, stone, sand, gods or the corresponding. Said lifting arms 60a, 60b are arranged to lift and lower the dredger ladle 60 and also comprises according to a variant means for turning the dredger ladle 60 for receiving and removing of load L.

The front vehicle unit 10 has a centre of gravity G1 based upon physics of the front vehicle unit 10 comprising weight, density, dimension and shape of the same. The rear vehicle unit 10 has a centre of gravity G2 based upon the vehicle physics of the rear vehicle unit 10 comprising weight, density, dimension and shape of the same. The dredger ladle 60 has a centre of gravity G3 based upon the physics of the dredger ladle 60 and the load L of the dredger ladle 60.

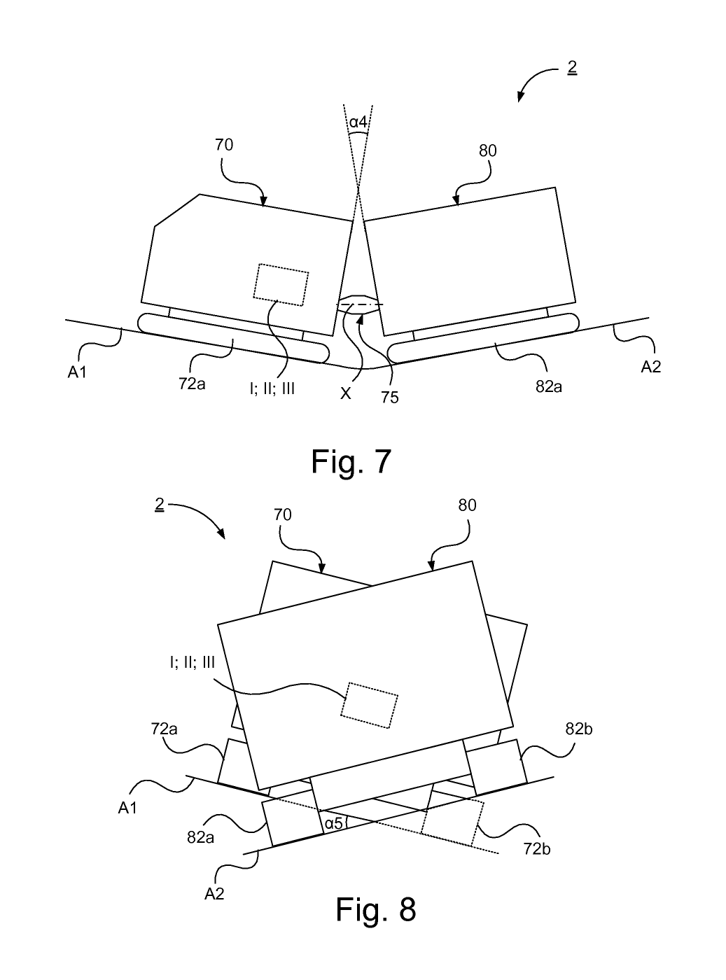

The articulated vehicle 1 has a centre of gravity G which depends on position of the dredger ladle 60, load L of the dredger ladle, angle of the vehicle 1, i.e. mutual angle between the respective longitudinal extension of the front and rear vehicle units 10, 20 called articulation angle α1, possible tilt angle between the vehicle units 10, 20 (see FIG. 7), possible roll angle between the vehicle units (see FIG. 8), the orientation of the vehicle relative to the horizontal plane H comprising inclination of the vehicle 1 comprising inclination of the vehicle 1 in a hill, wherein the ground A forms an angle α2 relative to the horizontal plane H in the longitudinal extension of the vehicle and side inclination/roll of the vehicle 1, wherein the ground A forms an angle α3 to the horizontal plane H.

The articulated vehicle comprises an electronic control unit 100; 200; 300 connected to the differential control units 50, 52, the electronic control unit 100; 200; 300 and the differential control units 50, 52 being comprised in a system for controlling the differential configuration of the vehicle.

The electronic control unit 100; 200; 300 is arranged to in a normal case of prevalent vehicle drive keeping the differential configuration 40 in a locked condition for securing the traction capability of the vehicle. The electronic control unit 100; 200; 300 is further arranged to control the differential configuration 40 to a non-locked condition by deviations from said normal case of prevalent vehicle drive represented by predetermined vehicle parameters for continued securing of the traction capability of the vehicle. Said vehicle parameters comprises according to a variant centre of gravity position of the vehicle 1, and speed of the vehicle and drive torque of the vehicle. Hereby the electronic control unit according to a variant is arranged to control the vehicle 1 based upon centre of gravity positions G of the vehicle.

FIG. 1 schematically shows a plan view of the articulated vehicle 1, wherein the vehicle 1 is arranged for drive straight ahead, the front and rear vehicle units 10, 20 being aligned along their respective longitudinal extension. The vehicle 1 is in a loaded condition wherein the dredger ladle 60 of the vehicle 1 is filled with load L.

FIG. 2 schematically shows a plan view of the articulated vehicle 1, wherein the vehicle 1 is arranged for drive in a turning direction departing from the direction straight ahead, the longitudinal extension of front and rear vehicle units 10, 20 mutually forming an articulation angle α1 relative to each other. Hereby the centre of gravity position G of the vehicle is changed such that the centre of gravity G of the vehicle 1 is moved relative to the centre of gravity position of the centre of gravity G of the vehicle in FIG. 1.

FIG. 3 schematically shows a side view of the articulated vehicle 1, wherein the dredger ladle 60 of the vehicle 1 is loaded and in a lowered position. The vehicle 1 is in this view driving on an essentially horizontal ground A.

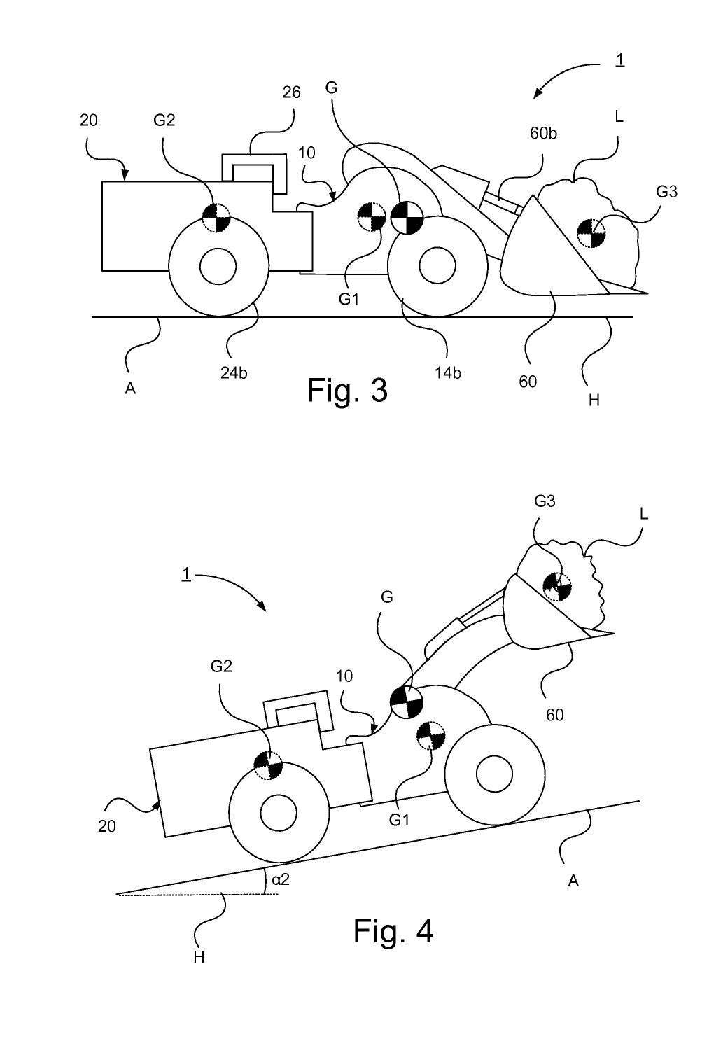

FIG. 4 schematically shows a side view of the articulated vehicle 1, wherein the dredger ladle 60 of the vehicle is loaded and in an elevated position. The vehicle 1 is in this view driving in an uphill slope, i.e. on a ground A having an inclination forming an angle α2 relative to the horizontal plane H. Due to the fact that the dredger ladle 60 is in an elevated position the position of the centre of gravity G of the vehicle 1 is changed such that the centre of gravity G of the vehicle is moved relative to the centre of gravity position of the centre of gravity G of the vehicle in FIG. 3.

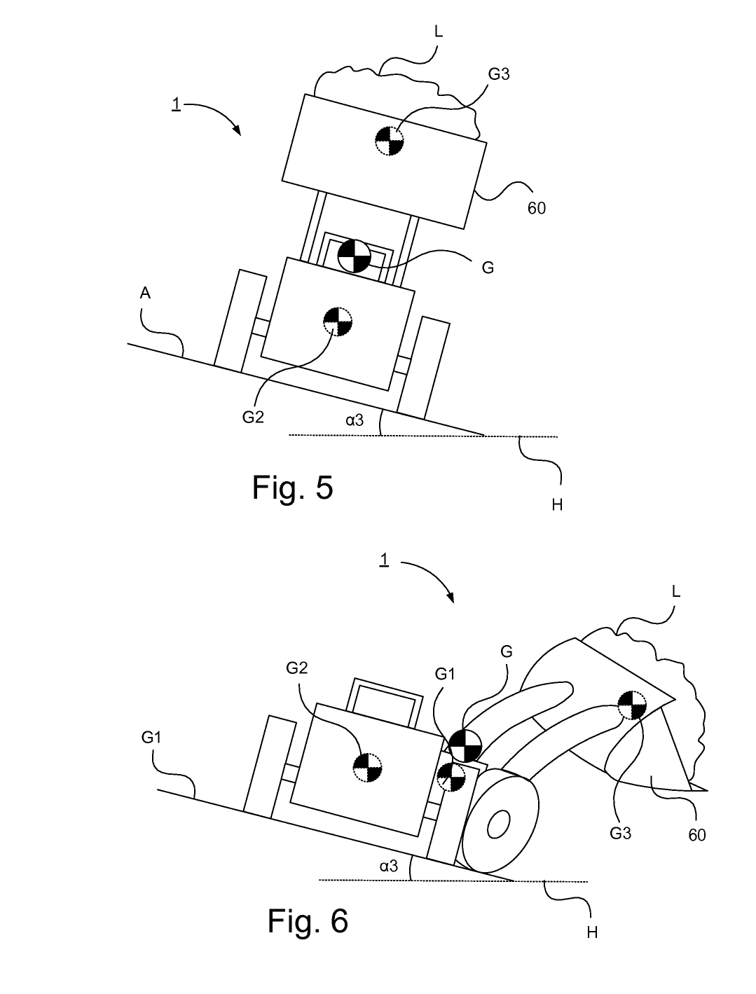

FIG. 5 schematically shows a view viewed from the back of the articulated vehicle 1, wherein the dredger ladle 60 of the vehicle 1 is loaded and in an elevated position. The vehicle 1 is arranged for drive straight ahead, the front and rear vehicle units 10, 20 being aligned along their respective longitudinal extension. The vehicle 1 is in this view driving in a side inclination, i.e. on a ground having an inclination relative to the horizontal plane transverse to the longitudinal extension of the vehicle 1 forming an angle α3 between ground A and horizontal plane H.

FIG. 6 schematically shows a perspective view from the back of the articulated vehicle 1, wherein the dredger ladle 60 of the vehicle 1 is loaded and in an elevated position. The vehicle 1 is arranged for drive in a turning direction departing from the direction straight ahead, the front and rear vehicle units 10, 20 mutually forming an articulation angle relative to each other. The vehicle 1 is in this view driving in a side slope, i.e. on a ground having an inclination relative to the horizontal plane transverse to the longitudinal extension of the rear vehicle unit 10. Hereby the centre of gravity position of the vehicle is changed such that the centre of gravity G of the vehicle 1 is moved relative to the centre of gravity position of the centre of gravity G of the vehicle in FIG. 5.

FIG. 7-8 schematically illustrate different views of a motor vehicle 2 according to the present invention. The motor vehicle 1 is according to this embodiment constituted by an articulated tracked vehicle 2 arranged to be driven by means of drive members in the form of drive tracks. The articulated vehicle 2 comprises a front vehicle unit 70 with front drive tracks 72a, 72b and a rear vehicle unit 80 with rear drive tracks 82a, 82b. According to an alternative only the front tracks are driving. The front and rear vehicle units 70, 80 are steerably interconnected by means of a steering device 75. The front and rear vehicle units 70, 80 are pivotable about the steering device 75, according to a variant in accordance with the embodiments in FIG. 1-6.

The articulated vehicle 2 comprises a not shown driveline for drive of the vehicle 2, where the driveline may be constituted by any suitable driveline comprising drive means such as electric motor and/or combustion engine for propulsion of the vehicle and transmission configuration connected to said drive means for transmission of power from the motor to output drive assemblies for drive of said tracks 72a, 72b, 82a, 82b. The driveline further comprises a differential configuration comprised in the transmission configuration for transferring drive torque to the driven tracks 72, 72b, 82a, 82b.

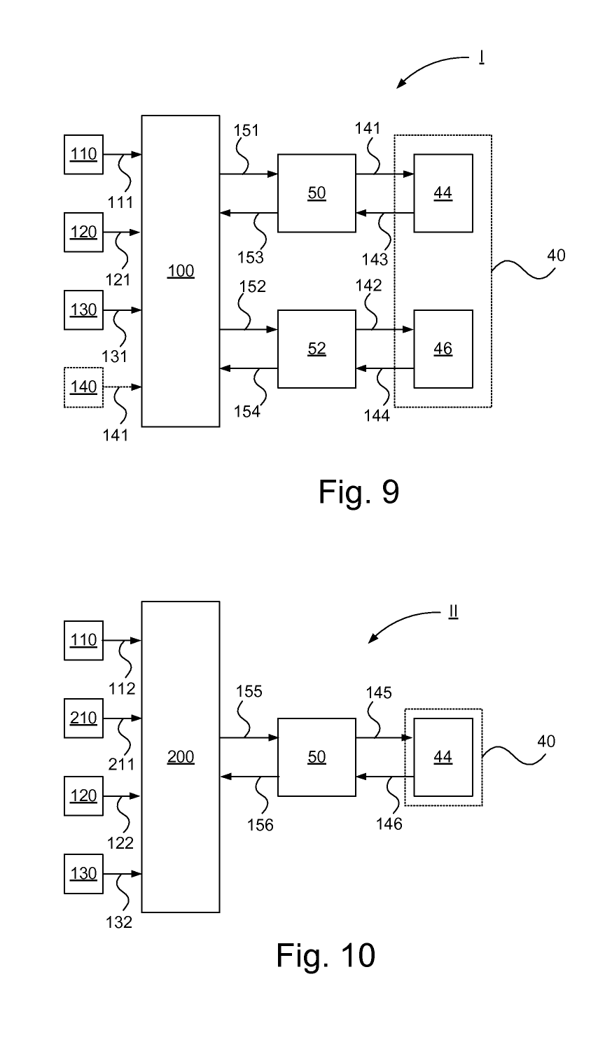

The articulated vehicle comprises a system I; II; III for controlling a differential configuration for the drive tracks of the motor vehicle arranged for differential drive, said steering being arranged to be effected in accordance with any of the embodiments described in connection to FIG. 1-6, FIG. 9-11 and FIG. 13a.

FIG. 7 schematically illustrates a side view of the motor vehicle 2 wherein the front vehicle unit 70 and the rear vehicle unit 80 are tilted relative to each other such that a tilt angle α4 is formed between the front and rear vehicle units 70, 80. Hereby the front vehicle unit 70 is arranged in an uphill slope on an inclined ground A1, and the rear vehicle unit 80 is arranged in a downhill slop, on an inclined ground A2. The front and rear vehicle units 70, 80 are hereby turned relative to each other about at least one axle of the steering device 75.

FIG. 8 schematically illustrates a view from behind of the motor vehicle 2 wherein the front vehicle unit 70 and the rear vehicle unit 80 are rolled relative to each other such that a roll angle α5 is formed between the front and rear vehicle units 70, 80. Hereby the front vehicle unit 70 is in a position such that it leans obliquely to the right, on an inclined ground A1, and the rear vehicle unit 80 is in a position such that it leans obliquely to the left, on an inclined ground A2. The front and rear vehicle units are hereby turned relative to each other about at least one roll axle Z of the steering device 75.

FIG. 9 schematically shows a block diagram of a system I for controlling a differential configuration according to an embodiment of the present invention. The system I comprises an electronic control unit 100 for said control.

The system I comprises a steering angle determination member 110 for sensing the degree of turn of the vehicle. The steering angle determination member 110 according to an embodiment comprises an articulation angle sensor arranged to sense mutual angle formed between a longitudinal extension of a front and rear vehicle unit of an articulated vehicle. The steering angle determination member 110 according to an embodiment comprises a steering gear angle sensor for sensing steering gear angle deflection of the vehicle. The steering angle determination member 110 according to an embodiment comprises a wheel angle sensor for sensing wheel angle deflection of the vehicle.

The system I further comprises a speed determination member 120 for determining the speed of the vehicle. The speed determination member 120 may be constituted by any suitable speedometer/speed sensor.

The system I in addition comprises drive torque determination members 130 for determining drive torque of the vehicle.

According to a variant the system I comprises a gyro for determining the inclination relative to the horizontal plane.

According to a variant the system I comprises a not shown tilt angle determination member for determining tilt angle e.g. in accordance with FIG. 7 for an articulated vehicle, vehicle with a trailer or the corresponding, and/or a not shown roll angle determination member for determining roll angle in accordance with FIG. 7 for an articulated vehicle, vehicle with trailer or the corresponding. The tilt angle determination member and/or roll angle determination member are according to a variant comprised in the steering angle determination member 110 and/or the gyro 140.

The system I comprises a first differential control unit 50 for in a normal case of prevalent vehicle drive keeping a first differential device 44 of a differential configuration 40 in a locked condition for securing the traction capability of the motor vehicle, e.g. according to FIG. 1-6 or 7-8. The first differential control unit 50 is consequently arranged to in a default position keeping the first differential device 44 in a locked condition.

The system I comprises a second differential control unit 52 for in a normal case of prevalent vehicle drive keeping a second differential device 46 of the differential configuration 40 in a locked condition for securing the traction capability of the motor vehicle, e.g. according to FIG. 1-6 or 7-8. The second differential control unit 52 is consequently arranged to in a default position keeping the second differential device 46 in a locked condition.

The electronic control unit 100 is signal connected to the steering angle determination member 110 via a link 111. The electronic control unit is via the link 111 arranged to receive a signal from the steering angle determination member 111 representing vehicle turn data.

The electronic control unit 100 is signal connected to the speed determination member 120 via link 121. The electronic control unit is via the link 121 arranged to receive a signal from the speed determination member 120 representing speed data of the vehicle.

The electronic control unit 100 is signal connected to said drive torque determination member 130 via a link 131. The electronic control unit 100 is via the link 131 arrange to receive a signal from the drive torque determination member 130 representing drive torque data of the vehicle.

The electronic control unit 100 is signal connected to said gyro via a link 141. The electronic control unit 100 is via the link 141 arranged to receive a signal from the gyro 140 representing vehicle orientation data.

The electronic control unit 100 is arranged to on the bases of said vehicle turn data, speed data, drive torque data and, where applicable, said vehicle orientation data, determine a vehicle condition. The electronic control unit is consequently arranged to on the basis of vehicle parameters comprising vehicle turn, vehicle speed, drive torque and where applicable vehicle orientation, determine the drive torque distribution of the drive members.

The electronic control unit 100 is signal connected to said first differential control unit 50 via a link 151. The electronic control unit 100 is arranged to via the link 151 send a signal to the first differential control unit 50 representing vehicle condition data comprising information about said vehicle condition.

The electronic control unit 100 is signal connected to said second differential control unit 52 via a link 152. The electronic control unit 100 is arranged to via the link 152 send a signal to the second differential control unit 52 representing vehicle condition data comprising information about said vehicle condition.

The first differential control unit 50 is signal connected to the first differential device 44 via a link 141. The first differential control unit 50 is arranged to via the link 141 send a signal to the first differential device 44 representing drive torque data constituting information about desired drive torque based upon said vehicle condition data sent from the electronic control unit 100.

The second differential control unit 52 is signal connected to the second differential device 46 via a link 142. The second differential control unit 52 is arranged to via the link 142 send a signal to the second differential device 46 representing drive torque data constituting information about desired drive torque based upon said vehicle condition data sent from the electronic control unit 100.

The first differential control unit 50 is signal connected to the first differential device 44 via a link 143. The first differential control unit 50 is arranged to via the link 143 receive a signal from the first differential device 44 representing drive torque data constituting information about actual drive torque.

The second differential control unit 52 is signal connected to the first differential device 46 via a link 144. The second differential control unit 52 is arranged to via the link 144 receive a signal from the second differential device 46 representing drive torque data constituting information about actual drive torque.

The electronic control unit 100 is signal connected to said first differential control unit 50 via a link 153. The electronic control unit 100 is arranged to via the link 153 receive a signal from the first differential control nit 50 representing drive torque data constituting information about actual drive torque.

The electronic control unit 100 is signal connected to said second differential control unit 52 via a link 154. The electronic control unit 100 is arranged to via the link 154 receive a signal from the second differential control unit 52 representing drive torque data constituting information about actual drive torque.

The electronic control unit 100 is arranged to compare said desired drive torque data to said actual drive torque data and, in case a difference exists, correct said determined vehicle condition such that the first and second differential control units 50, 52 controls the first and second differential device 44, 46 such that a desired drive torque for the actual vehicle condition is obtained in the respective drive member, e.g. drive wheels and drive tracks, of the vehicle for optimized traction capability.

The first differential control unit 50 is arranged to control the first differential device 44 to a non-locked condition and/or the second differential control unit 52 is arranged to control the second differential device 46 to a non-locked condition if said vehicle condition data departs from said normal case of prevalent vehicle drive, i.e. differs from predetermined normal vehicle conditions.

The first differential control unit 50 is arranged to keep the first differential device 44 in the locked condition and the second differential control unit 52 is arranged to keep the second differential device in the locked condition such that the differential configuration 40 is kept in the locked condition if said vehicle condition data lies within said normal case of prevalent vehicle drive, i.e. lies with said predetermined vehicle conditions.

Said non-locked condition of the first differential device 44 comprises a fully open condition of the first differential device 44, and partly open conditions of the first differential device 44.

Said non-locked condition of the second differential device 46 comprises a fully open condition of the second differential device 46, and partly open conditions of the second differential device 46.

In case of deviation from normal case of prevalent vehicle drive, i.e. departing from normal vehicle conditions, the first and/or second differential device 44, 46 will, depending on vehicle condition, open up to a suitable degree such that front and/or rear drive members are allowed to rotate with different speed.

The electronic control unit 100 is consequently arranged to in a normal case of prevalent vehicle drive, said determined vehicle condition lying within predetermined normal vehicle conditions, keeping the differential configuration 40 in a locked condition for securing the traction capability of the vehicle. The electronic control unit 100 is further arranged to control the differential configuration 40 to a non-locked condition by deviations from said normal case of prevalent vehicle drive represented by predetermined vehicle conditions differing from said predetermined normal vehicle conditions, for continued securing of the traction capability of the vehicle.

The electronic control unit 100 is consequently arranged to determine if and in that case to what extent the differential configuration 40 shall be allowed to be opened and consequently how much “slip” that shall be allowed in the differential configuration 40 by specific vehicle conditions, i.e. during specific drive situations for getting as close as possible to the optimal torque distribution of the drive members of a vehicle without preventing the traction capability of the vehicle.

The electronic control unit 100 is according to a variant arranged to control the differential configuration 40 to a non-locked condition if i) the steering angle exceeds a predetermined value and: the vehicle speed exceeds a first predetermined value and/or the drive torque is below a predetermined value, or ii) if the speed exceeds a second predetermined value which is greater than said first predetermined value.

FIG. 10 schematically shows a block diagram of a system II for controlling a differential configuration according to an embodiment of the present invention. The system II comprises an electronic control unit 200 for said control.

The system II comprises centre of gravity position determination member 210 for determining centre of gravity positions of the vehicle.

The system II further comprises a speed determination member 120 for determining the speed of the vehicle.

The system II in addition comprises drive torque determination member 130 determining drive torque of the vehicle.

The system II comprises a steering angle determination member 110, e.g. according to the embodiment described with reference to FIG. 9, for sensing the degree of turn of the vehicle.

The system II comprises according to a variant not sown tilt angle determination members and/or roll angle determination members, e.g. in accordance with the members described in connection to FIG. 9. Said tilt angle determination members and/or roll angle members are according to a variant comprised in the steering angle determination member and/or the gyro 140 according to below.

The system II comprises a differential control unit 50 for controlling a differential configuration 40 for at least two drive members of a motor vehicle for differential drive arranged between a locked and a non-locked condition in dependence of predetermined vehicle parameters. The differential configuration 40 comprises a differential device 44.

The electronic control unit 200 is signal connected to the centre of gravity position determination member 210 via a link 21. The electronic control unit 200 is via the link 211 arranged to receive a signal from the centre of gravity position determination member 210 representing vehicle centre of gravity position data.

The electronic control unit 200 is signal connected to the vehicle speed determination member 120 via link 122. The electronic control unit 200 is via the link 122 arranged to receive a signal from the vehicle speed determination member 120 representing speed data of the vehicle.

The electronic control unit 200 is signal connected to said drive torque determination member 130 via link 132. The electronic control unit 200 is via the link 132 arranged to receive a signal from the drive torque determination member 130 representing drive torque data of the vehicle.

The electronic control unit 200 is signal connected to the steering angle determination member 110 via a link 112. The electronic control unit is via the link 112 arranged to receive a signal from the steering angle determination member 110 representing vehicle turn data.

The electronic control unit 200 is on the basis of said centre of gravity position determination data, speed data, drive torque data and vehicle turn data determine a vehicle condition. The electronic control unit is consequently arranged to determine the torque distribution of the drive members on the bases of vehicle parameters comprising centre of gravity positions of the vehicle, vehicle speed, drive torque and vehicle turn.

The electronic control unit 200 is signal connected to said differential control unit 50 via a link 155. The electronic control unit 200 is arranged to via the link 155 send a signal to the differential control unit 50 representing vehicle condition data comprising information about said vehicle condition.

According to the embodiment described in connection to FIG. 9 the differential control unit 50 is signal connected to the differential device 44 via a link 145 and arranged to via the link 145 send a signal to the differential device 44 representing drive torque data constituting information about desired drive torque based upon said vehicle condition data sent from the electronic control unit 200.

The differential control unit 50 is further signal connected to the differential device 44 via a link 146 and arranged to via the link 146 receive a signal from the differential device 44 representing drive torque data constituting information about actual drive torque.

The electronic control unit 200 is signal connected to the differential control unit 50 via a link 156 and arranged to via the link 156 receive a signal from the differential control unit 50 representing drive torque data constituting information about actual drive torque.

The electronic control unit 200 is arranged to compare said desired drive torque data to said actual drive torque data and, in the case a difference exists, correct said determined vehicle condition such that the differential control unit 50 controls the differential device 44 such that desired drive torque for the actual vehicle condition is obtained in the respective drive member, e.g. drive wheels or drive tracks, of the vehicle for optimized traction.

The differential control unit 50 is arranged to control the differential device 44 between a locked and non-locked condition in dependence of centre of gravity positions of the vehicle. The differential control unit 50 is arranged to control the differential device 44 between a locked and non-locked condition based upon vehicle condition data comprising centre of gravity position data, speed data and drive torque data.

The differential control unit 50 is arranged to keep the differential device in a locked condition if said vehicle condition data lies within predetermined vehicle conditions, said vehicle conditions depending on centre of gravity position of the vehicle, speed of the vehicle, and torque of the vehicle.

According to a variant the differential control unit 50 is arranged to in a normal case of prevalent vehicle drive keep the differential device 44 of the differential configuration 40 in a locked condition for securing the traction capability of the vehicle. The differential control unit 50 is consequently according to a variant arranged to in a default position keeping the differential device 40 in a locked condition.

The electronic control unit 200 is consequently according to an embodiment in a normal case of prevalent vehicle drive, said determined vehicle condition lying within predetermined normal vehicle conditions comprising centre of gravity position of the vehicle, keeping the differential configuration 40 in a locked condition for securing the traction capability of the vehicle. The electronic control unit 200 is further arranged to control the differential configuration 40 to a locked condition by deviations from said normal case of prevalent vehicle drive represented by predetermined vehicle conditions comprising centre of gravity position of the vehicle differing from said predetermined normal vehicle condition, for continued securing of the traction capability of the vehicle.

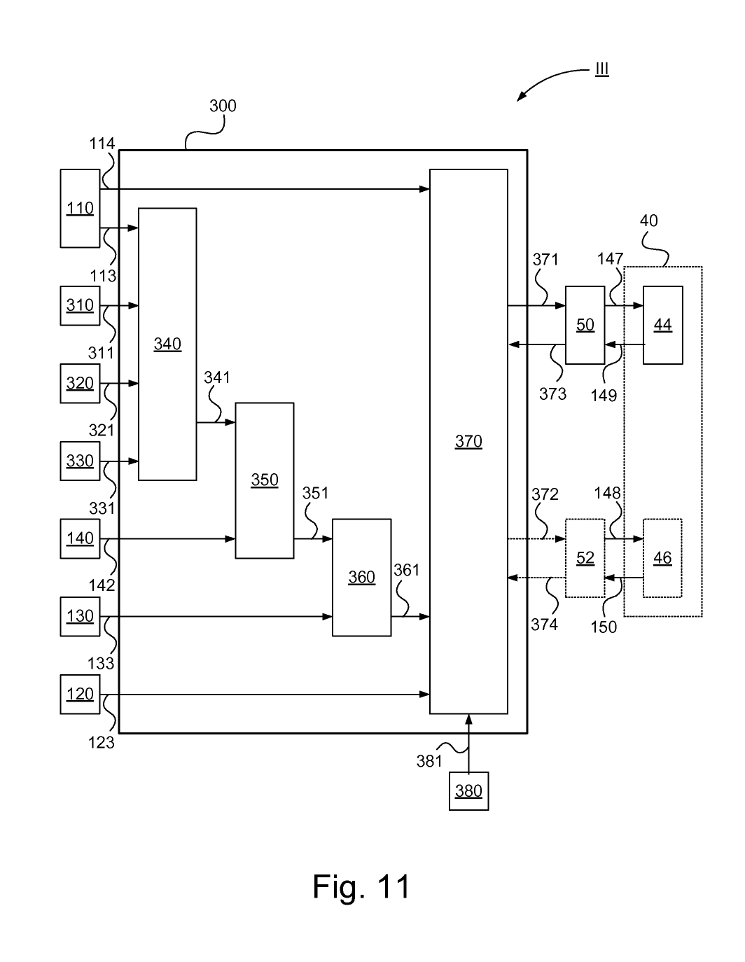

FIG. 11 schematically shows a block diagram of a system III for controlling of a differential configuration according to an embodiment of the present invention.

The system III comprises steering angle determination member 110 for sensing the degree of turn of the vehicle. The steering angle determination member 110 comprises according to an embodiment an angle sensor arranged to sense mutual angle formed between the longitudinal extension of the front and rear vehicle unit of an articulated vehicle. The steering angle determination member 110 comprises according to an embodiment a steering gear sensor for sensing the steering gear deflection of the vehicle. The steering angle determination member 110 comprises according to an embodiment a wheel angle sensor for determining wheel angle deflection of the vehicle.

The system III comprises vehicle physics determination member 310 comprising basic data such as weight, length, width, height, original weight distribution of the articulated vehicle, and weight, height, etc. of the respective vehicle unit.

The system III comprises load determination member 320 for determining load of the vehicle, where said load may be constituted by any load such as load in a dredger ladle of a vehicle e.g. as described with reference to FIG. 1-6, or load in a loading platform of a dumper of the like.

The system III further comprises elevation determination member 330 arranged to determine elevation of elevation changeable parts of the vehicle such as e.g. vertically adjustable dredger ladle according to the vehicle in FIG. 1-6, or a vertically adjustable loading platform of a vehicle.

The system III comprises a centre of gravity position determination module 340 for determining the centre of gravity position of the vehicle. The centre of gravity position determination module 340 is via a link 113 signal connected to said steering angle determination member. The centre of gravity determination module 340 is via the link 113 arranged to receive a signal representing vehicle turn data.

The centre of gravity position determination module 340 is via a link 311 signal connected to said vehicle physics determination member 310. The centre of gravity position determination module 340 is via the link 311 arranged to receive a signal representing vehicle physics data.

The centre of gravity position determination module 340 is via a link 321 signal connected to said load determination member 320. The centre of gravity position determination module 340 is via the link 321 arranged to receive a signal representing vehicle load data.

The centre of gravity position determination module 340 is via a link 331 signal connected to said elevation determination member 330. The centre of gravity position determination module 340 is via the link 331 arranged to receive a signal representing elevation data.

The centre of gravity position determination module 340 is arranged to determine the centre of gravity position of the vehicle based upon said vehicle turn data, vehicle physics data, vehicle load data and elevation data. The centre of gravity position determination module 340 is consequently arranged to determine the centre of gravity position of the vehicle based upon the vehicle parameters vehicle physics, vehicle load, which may be load in a dredger ladle or a loading platform, elevation of dredger ladle or loading platform or the corresponding, said physics data according to a variant being stored in the centre of gravity position determination module.

The system III also comprises a gyro 140 for determining orientation relative to the horizontal plane.

The system III further comprises a vehicle orientation module 350 in order to in addition pay attention to inclination of the ground.

The vehicle orientation module 350 is via a link 341 signal connected to said centre of gravity position determination module 340. The vehicle orientation module 350 is via the link 341 arranged to receive a signal representing centre of gravity position data.

The vehicle orientation module 350 is via a link 142 signal connected to said gyro 140. The vehicle orientation module 350 is via the link 142 arranged to receive a signal representing vehicle inclination data.

The vehicle orientation module 350 is arranged to determine the orientation of the vehicle relative to the horizontal plane based upon said centre of gravity position data and inclination data.

The system III further comprises a speed determination member 120 for determining the speed of the vehicle.

The system III in addition comprises drive torque determination member 130 for determining drive torque of the vehicle.

The system III also comprises a torque distribution optimization module 360 arranged to determine optimal drive torque distribution of drive wheels of the vehicle. The drive torque optimization is arranged to determine to what degree the differential configuration shall be opened in a specific drive condition of the vehicle.

The drive torque optimization module 360 is via a link 361 signal connected to said vehicle orientation module 350. The torque distribution optimization module 360 is via the link 361 arranged to receive a signal representing vehicle orientation data.

The torque distribution optimization module 360 is via a link 133 signal connected to said drive toque determination member 130. The torque distribution optimization module 360 is via the link 133 arranged to receive a signal representing drive torque data.

The drive torque optimization module 360 is arranged to determine optimal drive torque distribution based upon said vehicle orientation data and drive torque data.

The system III comprises a differential control module 370. The differential control module 370 is signal connected to the steering angle determination member 110 via a link 114. The differential control module 370 is via the link 114 arranged to receive a signal from the steering angle determination member 110 representing vehicle turn data.

The differential control module 370 is signal connected to the torque distribution optimization module 360 via a link 361. The differential control module 370 is via the link 361 arranged to receive a signal from the torque distribution optimization module 360 representing torque distribution data for optimal torque distribution of the vehicle.

The differential control module 370 is signal connected to the speed determination member 130 via a link 123. The differential control module 370 is via the link 123 arranged to receive a signal from the speed determination member 120 representing vehicle speed data.

The differential control module 370 is arranged to determine vehicle conditions based upon said vehicle turn data, torque distribution data and vehicle speed data. The differential control module 370 is consequently arranged to on the basis of vehicle parameters comprising vehicle turning, drive torque, and vehicle orientation determine the torque distribution of the drive members.

The system III further comprises at least one differential control unit 50, 52, e.g. in accordance with the differential control units described in connection to FIG. 9, for controlling a differential configuration 40 for at least two for differential drive arranged output ground engaging drive members such as dive wheels or drive tracks of a motor vehicle between a locked and a non-locked condition in dependence of predetermined vehicle parameters. The differential configuration 40 comprises at least on differential device 44, 46. Here a first and a second differential control unit 50, 52 are shown.

The differential control module 370 is signal connected to said first differential control unit 50 via a link 371. The differential control module 370 is arranged to via the link 371 send a signal to the first differential control unit 50 representing vehicle condition data comprising information about said vehicle condition.

The differential control module 370 is signal connected to said second differential control unit 52 via a link 372. The differential control module 370 is arranged to via the link 372 send a signal to the second differential control unit 52 representing vehicle condition data comprising information about said vehicle condition.

The first differential control unit 50 is arranged to control the first differential device 44 to a non-locked condition and/or the second differential control unit 52 is arranged to control the second differential device 46 to a non-locked condition if said vehicle condition data deviates from said normal case of prevalent vehicle drive, i.e. differs from said predetermined normal vehicle condition.

The first differential control unit 50 is arranged to keep the first differential device 44 in the locked condition and the second differential control unit 52 is arranged to keep the second differential control device 46 in the locked condition such the differential configuration 40 is kept in the locked condition if said vehicle condition data lies within said normal case of prevalent vehicle drive, i.e. lies within said predetermined vehicle condition.

The first differential control unit 50 is signal connected to the first differential device 44 via a link 147. The first differential control unit 50 is arranged to via the link 147 send a signal to the first differential device 44 representing drive torque data constituting information about desired drive torque based upon said vehicle condition data sent from the electronic control unit 300.

The differential control unit 52 is signal connected to the second differential device 46 via a link 148. The second differential control unit 52 is arranged to via the link 148 send a signal to the second differential device 46 representing drive torque data constituting information about desired drive torque based upon said vehicle condition data sent from the electronic control unit 300.

The first differential control unit 50 is signal connected to the first differential device 44 via a link 149. The first differential control unit 50 is arranged to via the link 149 receive a signal from the first differential device 44 representing drive torque data constituting information about actual drive torque.

The second differential control unit 52 is signal connected to the second differential device 46 via a link 150. The second differential control unit 52 is arranged to via the link 150 receive a signal from the second differential device 46 representing drive torque data constituting information about actual drive toque.

The differential control unit 370 is signal connected to said first differential control unit via a link 373. The differential control module 370 is arranged to via the link 373 receive a signal from the first differential control unit 50 representing drive toque data constituting information about actual drive toque.

The differential control module 370 is signal connected to said second differential control unit via a link 374. The electronic control unit 300 is arranged to via the link 374 receive a signal from the second differential control unit 52 representing drive torque data constituting information about actual drive torque.

The differential control module 370 is arranged to compare said desired drive torque data to said actual drive torque data and, in the case a difference exists, correct said determined vehicle condition such that the first and second differential control unit 52 controls the first and second differential device 46 such that desired drive torque for the actual vehicle condition is obtained in the respective ground engaging member, e.g. drive wheels, of the vehicle for optimized tractability.

The differential control module 370 is arranged to control the differential configuration 40 between a locked and a non-locked condition in dependence of centre of gravity positions of the vehicle. The differential control module 370 is according to an embodiment arranged to in a normal case of prevalent vehicle drive, where said determined vehicle condition lies within predetermined normal vehicle conditions, keeping the differential configuration 40 in a locked condition for securing the traction capability of the vehicle. The differential control module 370 is further arranged to control the differential configuration 40 to a non-locked condition by deviations from said normal case of prevalent vehicle drive represented by predetermined vehicle conditions differing from said predetermined normal vehicle conditions, for continued securing of the traction capability of the vehicle.

The system III comprise an actuator 380 for manually overriding the differential control. The actuator 380 is via a link 381 signal connected to said differential control module. The actuator is, when activated, arranged to via the link 381 send a signal to the differential control module 370 to control the differential configuration 40 in accordance with wishes from operator/driver. The actuator 380 has according to an embodiment the function positions on and off, where the position on means that the differential configuration 40 is fully locked, i.e. ends up in its normal position, such that all drive members such as drive wheel or drive tracks rotate with the same speed, and the position off means that the differential configuration 40 is fully opened such that the differential function of the differential configuration 40 is fully utilized. According to an alternative embodiment the actuator 380 in addition to the positions off and on also positions there between such that the operator/driver manually can control the differential configuration to desired degree of opening.

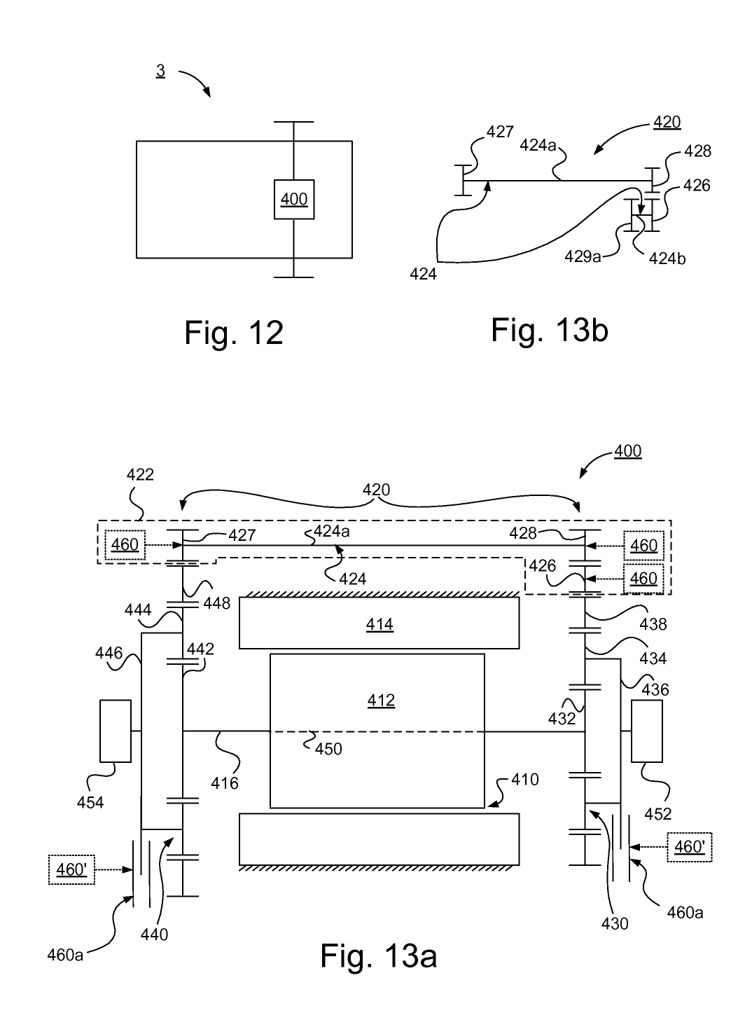

FIG. 12 schematically illustrates a motor vehicle 3 comprising a transmission configuration/differential configuration 400 according to the present invention. Said motor vehicle 3 may be constituted by a work vehicle such as an articulated vehicle. The motor vehicle 3 may be constituted by a multi wheeled vehicle. The motor vehicle 3 may be constituted by a vehicle with trailer. The motor vehicle 3 may be constituted by a tracked vehicle.

FIG. 13a schematically illustrates a transmission configuration 400 which comprises/constitutes a differential configuration 400 or a differential device for providing of a differential function and FIG. 13b schematically illustrates a differential arrangement 420 arranged to be controlled by means of a system I; II; III according to the present invention. The transmission configuration 400 comprises the differential arrangement 420. The transmission configuration 400 comprises the differential arrangement 420. The transmission configuration 400 comprises an electric motor 410 with a rotor 412 and a stator 414, said rotor 412 being connected to a drive shaft 416, said rotor 412 being arranged to rotate said drive shaft 416.

Said differential arrangement 420 comprises a first planetary gear configuration 430 and a second planetary gear configuration 440, said motor 410 being arranged between said first and second planetary gear configuration 430, 440.

The second planetary gear configuration 440 is in driving engagement with said first planetary gear configuration 430 via an output shaft 450 rotatable relative to and essentially engaged to said drive shaft 416.

The output shaft 450 is aligned with the drive shaft 416. The drive shaft 416 is according to an embodiment a hollow drive shaft 416 driven by the motor 410 and the output shaft 450 extends through, and is arranged to rotate freely in the hollow shaft 416.

The first planetary gear configuration 430 is drivingly connected to a first drive member 452. The second planetary gear configuration is drivingly connected to a second drive member 454. The first and second drive member 452, 454 are ground engaging members arranged to impel a motor vehicle, said drive members according to an embodiment being constituted by drive wheels and according to another embodiment by drive tracks. The drive members comprise according to a variant a gear reduction configuration such as a planetary gear configuration for providing gear reduction at ground engagement.

The first planetary gear configuration 430 comprises a sun gear 432, a set of planetary gears 434 carried by a carrier 436, and a ring gear 438. In the first planetary gear configuration 430 the sun gear 432 is in mesh with the set of planetary gears 434, and the set of planetary gears 434 is in mesh with the ring gear 438. The carrier 436 of the first planetary gear configuration 430 is arranged to transmit output drive torque to the first drive member 452.

The second planetary gear configuration 440 comprises a sun gear 442, a set of planetary gears 444 carried by a carrier 446, and a ring gear 448. In the second planetary gear configuration 440 the sun gear 442 is in mesh with the set of planetary gears 444, and the set of planetary gears 444 is in mesh with the ring gear 448. The carrier 446 of the second planetary gear configuration 440 is arranged to transmit drive torque to the second drive member 454.

The second planetary gear configuration 440 is in mesh with said first planetary gear configuration 430 via the output shaft 450 such that the sun gear 432 of the first planetary gear configuration 430 is connected to the sun gear 442 of the second planetary gear configuration 440 through said output shaft 450.

The differential arrangement 420 further comprises a reversing assembly 422, wherein the ring gears 438, 448 of the first and second planetary gear configurations 430, 440 are engaged via said reversing assembly 422 for said differential function. Said reversing assembly 422 is separated from the drive shaft 416 and thus from drive by the transmission configuration 400. Said reversing assembly 422 comprises a shaft configuration 424 separated from said drive shaft 416 and separated from said output shaft 450.

Said reversing assembly 422 comprises a rotational direction change configuration, connected to the ring gear 438, 448 of the first and second planetary gear configuration 430, 440 via said shaft configuration 424.

Said reversing assembly 422 is according to this embodiment connected between the ring gear 438 of the first planetary gear configuration 430 and the ring gear 448 of the second planetary gear configuration 440 such that when the ring gear 438 of the first gear configuration is allowed to rotate in one rotational direction with a certain rotational speed the ring gear 448 of the second planetary gear configuration 440 rotates in the opposite rotational direction with substantially the same rotational speed as the ring gear 438 of the first planetary gear configuration 430.

The ring gear 438, 448 rotating in the forward direction provides an increased rotational speed of the output shaft of the carrier 436, 446 of that planetary gear configuration 430, 440, and the ring gear 448, 438 rotating in the backward direction provides a corresponding decreased rotational speed of the output shaft of the carrier 446, 436 of that planetary gear configuration 440, 430.

For example, if the ring gear 438 of the first planetary gear configuration 430 rotates in the forward direction, providing an increased rotational speed of the output shaft of carrier 436, the ring gear 448 of the second planetary gear configuration 440 rotates in the backward direction, providing a decreased rotational speed of the output shaft of carrier 446.

The sum of the rotational speed of the output shaft of the respective carrier 436, 446 is constant for a constant rotational speed of the motor, independent of which ring gear 438, 448 rotating in the forward or backward direction, rotational speed of the respective ring gear or if the ring gears are locked, i.e. not rotating such that output shaft of the respective carrier 436, 446 rotates in the same rotational speed.

For example, if the rotational speed of the motor is 3000 rpm, in the case when the ring gears are at stand still, the respective carrier 436, 446 rotates in the same rotational direction at 1000 rpm, the sum being 2000 rpm, and in the case when the first ring gear rotates at a certain rotational speed in the forward direction and the second ring gear rotates at the same rotational speed in the backward direction, carrier 436 rotates in the forward direction at e.g. 1100 rpm, carrier 446 will rotate in the forward direction at 900 rpm.

As schematically illustrated in FIG. 13a said reversing assembly 422 comprises a first gear 426 in mesh with the ring gear 438 of the first planetary gear configuration 430, a second gear 427 in mesh with the ring gear 448 of the second planetary gear configuration 440 and a third gear 428 connected to the second gear 427 via said shaft configuration 424 constituted by a shaft 424a, and in mesh with the first gear 426, said first gear 426 and third gear 428 providing a change in rotational direction. The second and third gears 426, 427 are thus fixedly connected to the shaft 424a such that they rotate with the same rotational speed.

As may be partly seen from FIG. 13b, said reversing assembly 422 may instead of said third gear comprise a fourth gear 429a connected to the first gear 426 via a second differential shaft 424b, wherein the fourth gear is in mesh with a not shown fifth gear other, said fourth and fifth gear providing said rotational change. The shaft configuration 424 is according to this embodiment constituted by the first differential shaft 424a and second differential shaft 424b.

In the differential arrangement 420 the input power from the motor 410 is transferred to the sun gear 432, 442 of the first and second planetary gear configuration 430, 440, wherein in the output power is transferred from the shaft of the carrier 436, 446 of the first and second planetary gear configuration 430, 440 respectively to the respective output assembly 452, 454.

The differential arrangement 420 may be controlled to an open condition, i.e. the ring gear 438 of the first planetary gear configuration 440 and the ring gear 448 of the second planetary gear configuration 440 rotate in opposite rotational directions when final drive is subjected to different rotational speeds, e.g. when the final drive is connected to wheels of a vehicle and said vehicle is turning, i.e. driving in a curve.

As is shown in FIG. 13a the differential arrangement 420 may comprise any suitable differential control unit 460 for controlling the differential arrangement 420. The differential control unit 460 is arranged to be controlled based upon vehicle condition data from electronic control unit according to the present invention. Said differential control unit 460 may as shown in dotted lines in FIG. 13a be arranged in connection to the first gear 426, the second gear 427 or the third gear 428 for controlling the differential arrangement 428.

In FIG. 13a additional differential control units 460′ are illustrated. The differential control units 460′ are arranged in connection to the carrier 436 and/or carrier 446, wherein the differential control unit 460′ is arranged to via coupling members 160a provide power against the carrier 436 and/or carrier 446 for providing a differential function, wherein according to a variant the respective output assembly 452, 454 may be brought to rotate with the same rotational speed for facilitating optimal torque distribution.

The differential arrangement 420 comprises according to this embodiment the planet carriers 436, 446 of the transmission configuration 400. Consequently the transmission configuration 400 constitutes a differential configuration providing differential functions.

According to a variant locking of the respective carrier 436, 446 is facilitated by means of the differential control units 460′ such the respective output assembly is prevented from rotating such the drive of the vehicle is stopped. The differential control units 460′ may consequently be utilized as parking brake and emergency brake by locking in connection to the carriers 436, 446 by means of the same such that rotation of the output assemblies 452, 454, e.g. drive wheels are prevented.

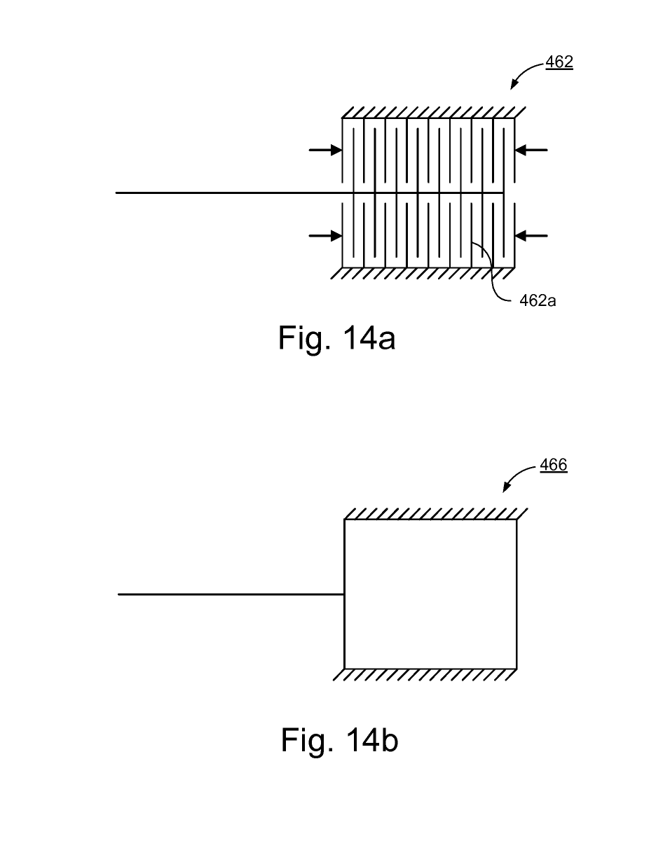

FIG. 14a schematically illustrates a differential control unit represented by a coupling configuration 462 being constituted by a multiple disc brake member 462 having a set of discs 462a for providing a braking action when subjected to a pressure, said multiple disc brake member 462 being operable to engage said reversing assembly 422 so as to facilitate control of said differential arrangement 420.

By means of a multiple disc brake member 462 control of braking is facilitated. Said multiple disc brake member 462 when activated provides a fully locked operating condition of the differential arrangement 420 during engagement of said reversing assembly 422, in which a total differential lock is provided such that first and second output assemblies 452, 454, e.g. ground engaging final drives in the form of drive wheels or drive tracks are locked to the same rotational speed, such that e.g. opposite wheels of a vehicle are forced to rotate with the same rotational speed. The system I; II; III according to embodiments of the present invention is by means of the multiple disc brake member 462 arranged to in a normal case of prevalent vehicle drive keep the differential configuration 400/differential arrangement 420 in a locked condition for securing the traction capability of the vehicle.

Said multiple disc brake member 462 further provides when activated a limited-slip operating condition during engagement of said reversing assembly 422, wherein the differential configuration 400/differential arrangement 420 is controlled such that a difference in rotational speed between the drive members 452, 454, e.g. opposite drive wheels or drive tracks of a vehicle, is required in order for the differential arrangement 420 to lock. Hereby prevention of relative wheel movement is provided by means of difference in rotational speed. The system I; II; III according to embodiments of the present invention is by means of the multiple disc brake member 462 by deviations from said normal case of prevalent vehicle drive arranged to control the differential configuration 400/differential arrangement 420 to a non-locked condition for continued securing of the traction capability of the vehicle.

FIG. 14b schematically illustrates a differential control unit constituted by a motor 466, e.g. an electric motor or a hydraulic motor, operable to engage said reversing assembly 422 so as to facilitate control of said differential arrangement 420. Said motor 410 provides torque-vectoring when operated to engage said reversing assembly 422, such that power from one drive member 452, 454, is transferable to the other drive member 452, 454. For example, when driving with a vehicle in a curve power from the inner wheel is transferred to the outer wheel. This function may be used for controlling the vehicle, e.g. steering of the vehicle.

The transmission configuration 400 with the differential arrangement 420 according to the present invention separated from the drive shaft 416 facilitates separation of high drive/low drive and differential drive.

The transmission configuration 400 with the differential arrangement 420 according to the present invention separated from the drive shaft 416 facilitates a differential lock described with reference to FIG. 14a and facilitated torque vectoring described above with reference to FIG. 14b.

The transmission configuration 400 with the differential arrangement 420 according to the present invention separated from the drive shaft 416 may advantageously be combined with power electronics, electronic control unit, hybrid drive, diesel electric drive etc.

The transmission configuration 400 with the differential arrangement 420 according to the present invention separated from the drive shaft 416 may comprise cooling of the electric motor 410 and gears, lubrication of gears, and resolvers for determining rotating parts.

The transmission configuration 400 with the differential arrangement 420 according to the present invention separated from the drive shaft 416 may be received in a housing, wherein said electric drive system 400 may be integrated with a drive shaft 416 of a motor vehicle. The drive shaft 416 may be rigidly suspended, pendulum suspended, damped etc.

The transmission configuration 400 according to the present invention may be longitudinally arranged in a four-wheel driven driveline.

The transmission configuration 400 with the differential arrangement 420 according to the present invention separated from the drive shaft 416 may be used for providing pivot turns, when differential control unit being constituted by a motor and low gear is used.

The transmission configuration 400 with the differential arrangement 420 according to the present invention separated from the drive shaft 416 may be used for traction control, when differential control unit is constituted by a motor and low gear is used.

The transmission configuration comprises sensor means for determining speed of output shafts of respective carriers 436, 446. Said sensor means may be arranged at any suitable location. Said sensor means is according to an embodiment a resolver for the respective carrier 436, 446.

The transmission configuration comprises means for determining rotor shaft speed and position. Said rotor shaft speed/position determination means may be constituted by a sensor member such as a resolver.

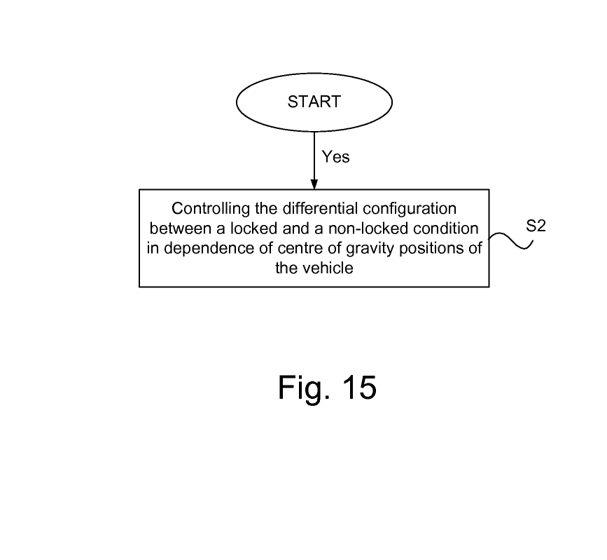

FIG. 15 schematically illustrates a block diagram of a method for controlling a differential configuration according to an embodiment of the present invention.

According to an embodiment the method for controlling a differential configuration comprises a first step S1. In this step the differential configuration between a locked and a non-locked condition in dependence of centre of gravity positions of the vehicle.

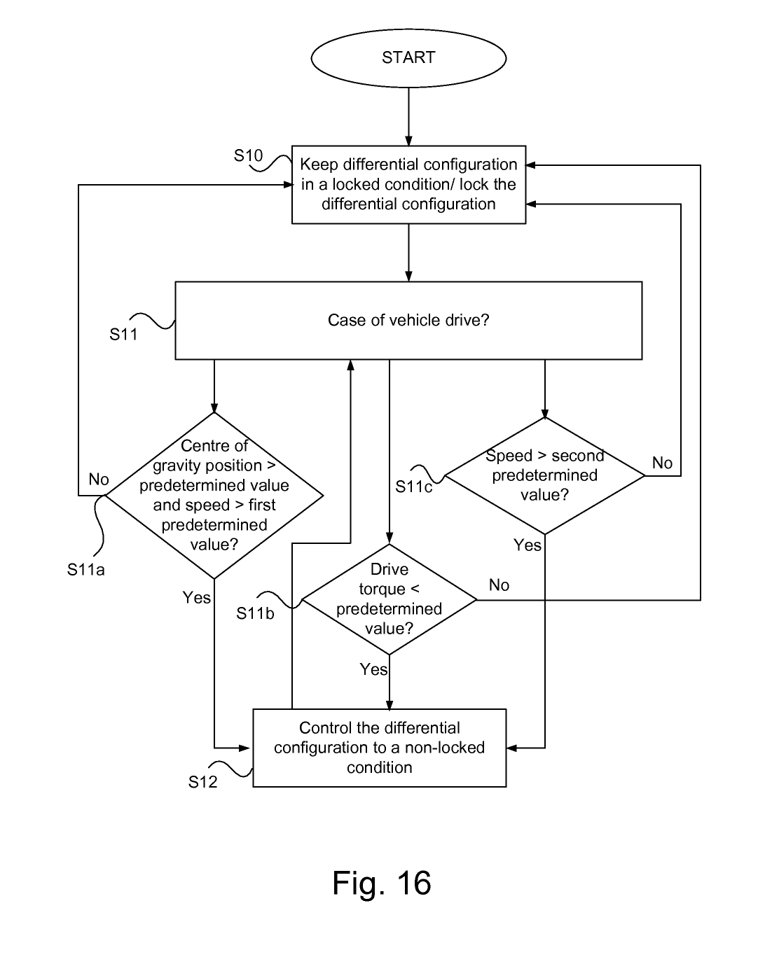

FIG. 16 schematically illustrates a block diagram of a method for controlling a differential configuration according to an embodiment of the present invention.

According to the embodiment the method comprises a step S10. In this step the differential configuration is kept in a locked condition.

According to the embodiment the method comprises a step S11. In this step the drive condition of the vehicle is checked.

According to an embodiment the method comprises a substep S11a. In this step it is checked in the drive condition of the vehicle whether the centre of gravity position exceeds a predetermined value and: the speed exceeds a first predetermined value, wherein, if these criteria are fulfilled, in a step S12 the differential configuration is controlled to a non-locked condition, wherein the drive condition of the vehicle is checked anew. In this step it is checked in the condition of the vehicle according to a variant also whether the steering angle exceeds a predetermined value (not shown), wherein if this criterion together with the other criteria, is fulfilled, the differential configuration is controlled to a non-locked condition, wherein the drive condition of the vehicle is checked anew.

According to an embodiment the method comprises a substep S11b. In this step it is checked in the drive condition of the vehicle whether the drive torque underpasses a predetermined value, wherein, if this criterion is fulfilled, in a step S12 the differential configuration is controlled to a non-locked condition, wherein the drive condition of the vehicle is checked anew.

According to an embodiment the method comprises a substep S11c. In this step it is checked in the drive condition of the vehicle whether the speed exceeds a second predetermined value being greater than said first predetermined value, wherein, if this criterion is fulfilled, in a step S12 the differential configuration is controlled to a non-locked condition, wherein the drive condition of the vehicle is checked anew.

If none of the criteria in the substeps 11a, 11b or 11c are fulfilled the differential configuration will, if the differential configuration is in the locked condition, be kept in the locked condition, and if the differential configuration is in the non-locked condition, the differential configuration will be controlled to the locked condition.

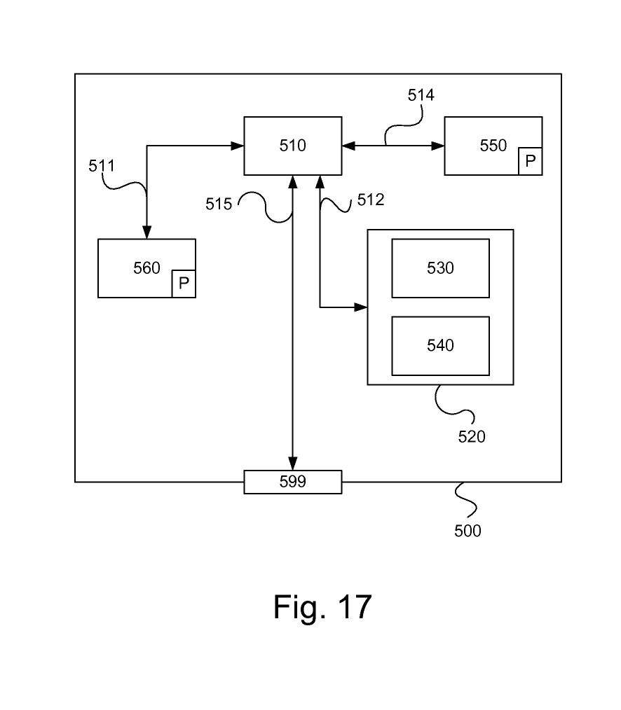

With reference to FIG. 17, a diagram of an apparatus 500 is shown. The control units 100; 200; 300 described with reference to FIG. 9-11 may according to an embodiment comprise apparatus 500. Apparatus 500 comprises a non-volatile memory 520, a data processing device 510 and a read/write memory 550. Non-volatile memory 520 has a first memory portion 530 wherein a computer program, such as an operating system, is stored for controlling the function of apparatus 500. Further, apparatus 500 comprises a bus controller, a serial communication port, I/O-means, an A/D-converter, a time date entry and transmission unit, an event counter and an interrupt controller (not shown). Non-volatile memory 520 also has a second memory portion 540.

A computer program P is provided comprising routines for facilitating control of a differential configuration according to the innovative method. The program P comprises routines for controlling the differential configuration between a locked and a non-locked condition in dependence of centre of gravity positions of the vehicle. The computer program P may be stored in an executable manner or in a compressed condition in a separate memory 560 and/or in read/write memory 550.

When it is stated that data processing device 510 performs a certain function it should be understood that data processing device 510 performs a certain part of the program which is stored in separate memory 560, or a certain part of the program which is stored in read/write memory 550.

Data processing device 510 may communicate with a data communications port 599 by means of a data bus 515. Non-volatile memory 520 is adapted for communication with data processing device 510 via a data bus 512. Separate memory 560 is adapted for communication with data processing device 510 via a data bus 511. Read/write memory 550 is adapted for communication with data processing device 510 via a data bus 514. To the data communications port 599 e.g. the links connected to the control units 100; 200; 300 may be connected.

When data is received on data port 599 it is temporarily stored in second memory portion 540. When the received input data has been temporarily stored, data processing device 510 is set up to perform execution of code in a manner described above. The signals received on data port 599 can be used by apparatus 500 for controlling the differential configuration between a locked and a non-locked condition in dependence of centre of gravity positions of the vehicle.

Parts of the methods described herein can be performed by apparatus 110 by means of data processing device 510 running the program stored in separate memory 560 or read/write memory 550. When apparatus 100 runs the program, parts of the methods described herein are executed.

The foregoing description of the preferred embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated.

1. A method for controlling a differential configuration (40; 400) for at least two for differential drive arranged drive wheels of a motor vehicle (1; 2; 3), said differential drive being arranged to assume a locked and an open position respectively comprising the step of controlling the differential configuration between a locked and a non-locked condition in dependence of predetermined vehicle parameters, characterized by the step of: controlling (S1) the differential configuration (40, 400) between a locked and a non-locked condition in dependence of centre of gravity positions of the vehicle.

2. A method according to claim 1, wherein the step of controlling the differential configuration (40, 400) between a locked and a non-locked condition also comprises any of the vehicle parameters speed, steering angle and drive torque.

3. A method according to claim 1 or 2, comprising the step of determining said centre of gravity positions of the vehicle based upon one or more vehicle parameters comprising steering angle, load and vehicle physics.

4. A method according to any of claims 1-3, comprising the step of: i) in a normal case of prevalent vehicle drive keeping the differential configuration (40; 400) in a locked condition for securing the traction capability; and ii) controlling the differential configuration (40, 400) to an non-locked condition by deviations from said normal case of prevalent vehicle drive represented by predetermined vehicle parameters comprising centre of gravity position of the vehicle for continued securing of the traction capability of the vehicle.

5. A method according to any of claims 1-4, comprising the step of controlling the differential configuration (40; 400) to said non-locked condition if i) the centre of gravity position of the vehicle differs from predetermined positions and: the speed exceeds a first predetermined value and/or the drive torque falls below a predetermined value, or ii) if the speed exceeds a second predetermined value being greater than said first predetermined value.

6. A method according to claim 5, comprising the step of controlling the differential configuration (40; 400) to a non-locked condition if i) the steering angle exceeds a predetermined value and: the speed exceeds a first predetermined value and/or the drive torque falls below a predetermined value, or ii) if the speed exceeds a second predetermined value being greater than said first predetermined value.

7. A method according to any of claims 1-6, comprising the step of: controlling the differential configuration (40; 400) to a determined mutual torque distribution of the drive members.

8. A system for controlling a differential configuration (40; 400) for at least two for differential drive arranged drive wheels of a motor vehicle (1; 2; 3), said differential drive being arranged to assume a locked and an open position respectively, means being presently arranged for controlling the differential configuration between a locked and a non-locked condition in dependence of predetermined vehicle parameters, characterized by means (200; 300; 50, 52, 460; 460′; 462; 466) for controlling the differential configuration (40, 400) between a locked and a non-locked condition in dependence of centre of gravity positions of the vehicle.

9. A system according to claim 8, wherein said means (200; 300; 50, 52, 460; 460′; 462; 466) for controlling the differential configuration (40, 400) between a locked and a non-locked condition also comprises any of the vehicle parameters speed, steering angle and drive torque.

10. A system according to claim 8 or 9, comprising means (110, 310, 320, 330, 340) for determining said centre of gravity positions of the vehicle based upon one or more vehicle parameters comprising steering angle, load and vehicle physics.

11. A system according to any of claims 8-10, comprising means (200; 300; 50, 52, 460; 460′; 462; 466) for in a normal case of prevalent vehicle drive keeping the differential configuration (40; 400) in a locked condition for securing the traction capability; and means (200; 300; 50, 52, 460; 460′; 462; 466) for controlling the differential configuration (40, 400) to an non-locked condition by deviations from said normal case of prevalent vehicle drive represented by predetermined vehicle parameters comprising centre of gravity position of the vehicle for continued securing of the traction capability of the vehicle.

12. A system according to any of claims 8-11, comprising means (200; 300; 50, 52, 460; 460′; 462; 466) for controlling the differential configuration (40; 400) to said non-locked condition if i) the centre of gravity position of the vehicle differs from predetermined positions and: the speed exceeds a first predetermined value and/or the drive torque falls below a predetermined value, or ii) if the speed exceeds a second predetermined value being greater than said first predetermined value.

13. A system according to claim 12, comprising means (200; 300; 50, 52, 460; 460′; 462; 466) for controlling the differential configuration (40; 400) to a non-locked condition if i) the steering angle exceeds a predetermined value and: the speed exceeds a first predetermined value and/or the drive torque falls below a predetermined value, or ii) if the speed exceeds a second predetermined value being greater than said first predetermined value.

14. A system according to any of claims 8-13, comprising means (200; 300; 50, 52, 460; 460′; 462; 466) for controlling the differential configuration (40; 400) to a determined mutual torque distribution of the drive members.

15. A differential configuration characterized in that it is arranged to be controlled by means of a system according to any of claims 6-10, wherein said differential configuration (400) comprises at least one differential arrangement (420) comprising a first planetary gear configuration (430) being drivingly connected to a first drive member (454), a second planetary gear configuration (440) being drivingly engaged to said first planetary gear configuration (430) via said output shaft (450), said second planetary gear configuration (440) being drivingly connected to a second drive member (454); an electric motor (410) being arranged between said first and second planetary gear configuration (430, 440), said first planetary gear configuration (430) being arranged to co-act with said second planetary gear configuration (440) for providing a differential function.

16. A differential configuration according to claim 15, wherein the ring gears (438, 448) of the first and second planetary gear configuration (430, 440) are engaged via a reversing assembly (422) for said differential function.

17. A differential configuration according to claim 16, wherein said reversing assembly (422) comprises a shaft configuration (424) separated from said drive shaft (416).

18. A differential configuration according to claim 16 or 17, wherein said reversing assembly (422) comprises a rotational direction change configuration, connected to the ring gears (438, 448) of the first and second planetary gear configurations (430, 440) via said shaft configuration.

19. A differential configuration according to any of claims 16-18, wherein at least one differential control unit (460; 462; 464; 466) presently arranged, being operable to engage and disengage said reversing assembly (422) for controlling said differential configuration (420).

20. A differential configuration according to claim 19, wherein said at least one differential control unit (460; 462; 464; 466) comprises a coupling configuration (462, 464) for braking said reversing assembly (422).

21. A differential configuration according to claim 19, wherein said at least one differential control unit comprises a motor (466).

22. A differential configuration according to any of claims 15-21, wherein at least one differential control unit (460′) is presently arranged to block a first and/or second carrier (436, 446) of the planetary gear configuration (430, 440).

23. A differential configuration according to claim 22, wherein said at least one differential control unit (460′) is arranged to lock said first and second carrier (436, 446) such that rotation of drive members is prevented.

24. A motor vehicle comprising a system (I; II; III) according to any of claims 7-14.

25. A motor vehicle according to claim 20, comprising a differential configuration according to any of claims 15-23.

26. A motor vehicle according to claim 24 or 25, wherein the motor vehicle is constituted by an articulated vehicle.

27. A computer program (P) for controlling a differential configuration for at least two for differential drive arranged drive members of a motor vehicle, said differential drive being arranged to assume a locked and an open condition respectively when controlled by the differential configuration between a locked and a non-locked condition in dependence of predetermined vehicle parameters, said computer program (P) comprising program code which, when run an electronic control unit (100; 200; 300; 500) or another computer (500) connected to the electronic control unit (100; 200, 300; 500), causes the electronic control unit perform the steps according to claim 1-6.

28. A computer program product comprising a digital storage medium storing the computer program according to claim 27.
